(19) United States
(12) Patent Application Publication
(10) Pub. No.: US 2011/0167910 A1
(43) Pub. Date: Jul. 14, 2011

(54) APPARATUS AND METHOD FOR DETECTING A PROPERTY OF A FLUID

(75) Inventors: Bruce H Storm, Houston, TX (US); James E Masino, Houston, TX (US)

(73) Assignee: HALLIBURTON ENERGY SERVICES, INC., Houston, TX (US)

(21) Appl. No.: 13/119,293

(22) PCT Filed: Sep. 16, 2009
(86) PCT No.: PCT/US2009/057073

§ 371 Date: Mar. 16, 2011

Related U.S. Application Data
(60) Provisional application No. 61/098,343, filed on Sep. 19, 2008.

(51) Int. Cl. G01N 9/36; G01N 29/036; E21B 47/14; E21B 49/00

(52) U.S. Cl. 73/32 A; 73/579; 73/152.58; 73/152.05

(57) ABSTRACT

An apparatus comprises a tensioned sample tube that receives a fluid sample, the tensioned sample tube has a pre-determined tension applied thereto. A vibration source and a vibration detector are coupled to the tensioned sample tube. A method of estimating a property of a fluid comprises tensioning a sample tube to a predetermined tension. A sample of the fluid is received in the tensioned sample tube. The tensioned sample tube is vibrated. A resonant frequency of the tensioned sample tube is detected. The property of the fluid is estimated based on the detected resonant frequency of the tensioned sample tube.

### BACKGROUND OF THE INVENTION

The present invention relates generally to devices and methods for measuring fluid properties in a flow stream, and more particularly, to devices and methods for measuring fluid properties in a wellbore.

There are many instances in industrial processes and controls for handling flowing fluids where it is desirable to accurately determine the density of the fluid. One example application is in the identification of reservoir fluids flowing in a well and/or from a downhole formation. As used herein, the term fluid is taken to mean any liquid, gas, or mixture thereof, including those which contain solids. It is often desirable to determine the amount of oil that is produced in a stream flowing from a formation. Water often co-exists with gaseous hydrocarbons and crude oil in some common geologic formations. As such, a mixture of water, gaseous hydrocarbons, and liquid hydrocarbons is often produced by a working oil well. Well logging tools, deployed either by wireline or drilling tubulars, may be used to determine properties of the formation fluids in situ, in order to determine the potential hydrocarbon content and the locations of formation water and gas interfaces.

### BRIEF DESCRIPTION OF THE DRAWINGS

A better understanding of the present invention can be obtained when the following detailed description of example embodiments are considered in conjunction with the following drawings, in which:

FIG. 1 shows an example of a single tube densitometer;

FIG. 2 shows another embodiment of a densitometer;

FIG. 3 shows one embodiment of the receiver and transmitter arrangements;

FIG. 3A is an electrical schematic depicting one embodiment of the receiver arrangement;

FIG. 4 shows an exemplary measurement module;

FIG. 5 shows a graph of an exemplary resonance peak;

FIG. 6 shows a method for adaptive tracking of a resonance frequency;

FIG. 7 shows a graph of a measured density as a function of time;

FIG. 8 shows a method for measuring resonance peak frequency, amplitude, and width;

FIG. 9 shows an example of a dual-tube densitometer;

FIG. 10A shows an example of an embodiment of a tensioned tube densitometer;

FIG. 10B shows a cross-section of FIG. 10A

FIG. 11A shows an example of another embodiment of a tensioned tube densitometer;

FIG. 11B shows an end view of the tensioned tube densitometer of FIG. 11A;

FIG. 11C shows another embodiment of a tensioned tube densitometer;

FIG. 11D shows an end view of the tensioned tube densitometer of FIG. 11C;

FIG. 11E shows another embodiment of a tensioned tube densitometer;

FIG. 11F shows an end view of the tensioned tube densitometer of FIG. 11E;

FIG. 12 is a chart showing predicted resonant frequencies vs. fluid density for a sample tube having no tension and a tensioned sample tube;

FIG. 13 shows examples of systems that may comprise a formation testing tool;

FIG. 14 is a diagram of a formation testing tool comprising a tensioned tube densitometer; and

FIG. 15 is a functional diagram of one embodiment of a measurement module for a vibrating tube densitometer.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention as defined by the appended claims.

### DETAILED DESCRIPTION

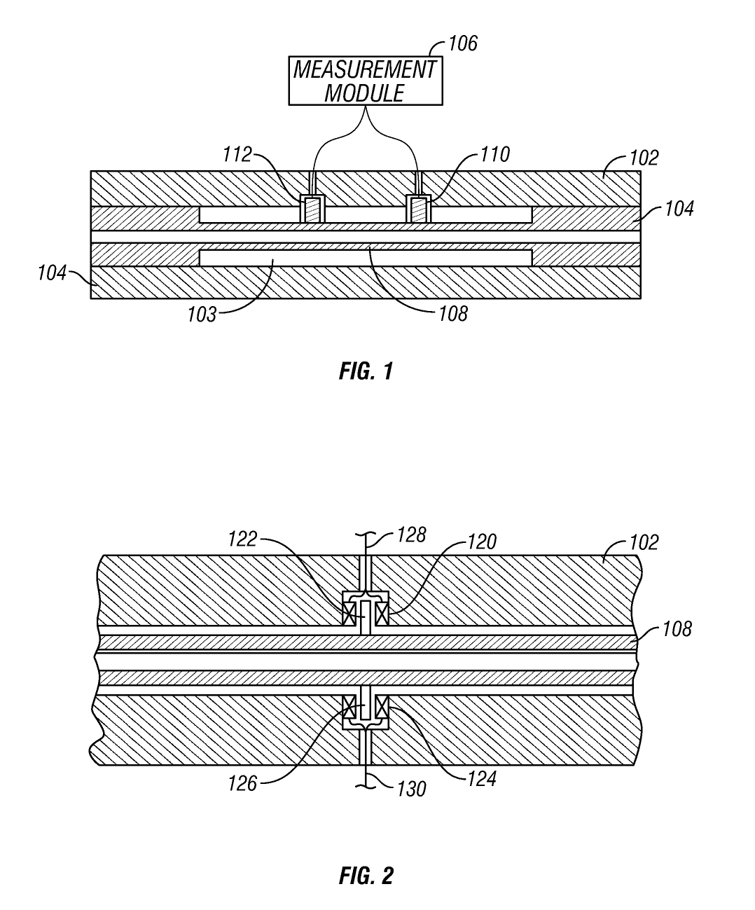

As used herein, the term fluid is taken to mean any liquid, gas, or mixture thereof, including those which contain solids. Referring now to FIG. 1, one embodiment of a device for measuring density and viscosity of a flowing fluid generally includes a rigid housing 102, two bulkheads 104, a flow tube 108, a vibration source 110, a vibration detector 112, and a measurement module 106. The rigid housing 102 surrounds and protects a volume 103 through which the flow tube 108 passes and reduces the response to vibrations not associated with particular vibratory modes of the flow tube 108. The bulkheads 104 seal the volume and secure the flow tube 108 within that volume. The volume 103 may contain air, a vacuum or a relatively inert gas such as nitrogen or argon. If gasses are used, then, in one embodiment, they may be at atmospheric pressure when the device is at room temperature.

The rigid housing 102, bulkheads 104, and flow tube 108 may be made from material in a configuration that can withstand pressures of more than 20,000 psi (pounds per square inch) at temperatures of 250° C., or more. Two examples of suitable metallic materials include, but are not limited to, titanium, titanium alloys, and high temperature nickel based alloys, for example Hastaloy-C276 brand alloy, manufactured by Haynes International, Inc. In one example, bulkheads 104 and the flow tube 108 may be constructed from a single piece of material, with the bulkheads 104 being regions of larger diameter on either end of the tube 108. Alternatively, the flow tube 108 may be welded to the bulkheads 104, or otherwise attached. The flow tube 108 may also be coupled to the rigid housing 102 by o-rings or other sealing techniques. In one example, the rigid housing 102, bulkheads 104, and the flow tube 108 may be constructed from the same material in order to alleviate thermally induced stresses when the system is in thermal equilibrium.

In one embodiment, flow tube 108 may be substantially straight, thereby reducing plugging and erosion of flow tube 108 by materials passing through flow tube 108. Alternatively, bent tubes of various shapes, including “U”-shaped tubes, may be used to provide greater measurement sensitivities. Contemplated dimensions for the embodiment of FIG. 1 are shown in Table 1:

TABLE 1

| | Flow Tube | Bulkhead | Housing |
|---|---|---|---|
| Length | 6″ | 2″ | 10″ |
| Outer Diam | 0.300″ | 1.5″ | 2″ |
| Inner Diam | 0.219″ | — | ~1.5″ |

However, it is noted that other dimensions may be used without departing from the scope of the invention.

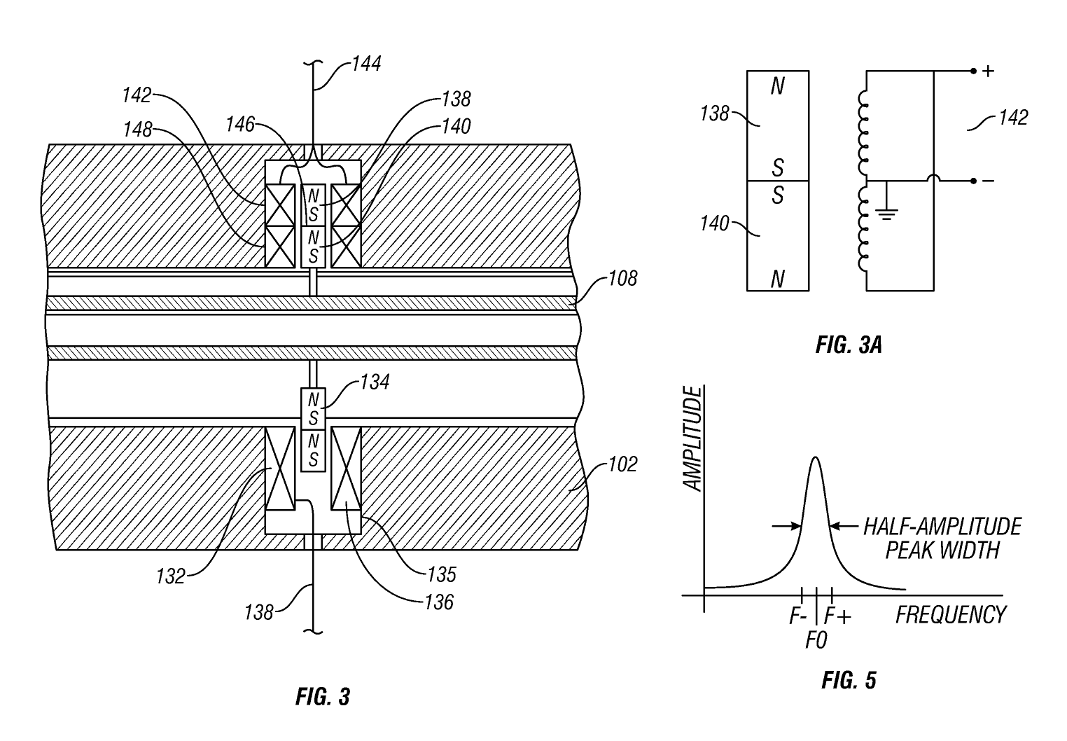

As described above, attached to the flow tube 108 are a vibration source 110 and a vibration detector 112. The vibration source 110 and vibration detector 112 may be located side by side as shown in FIG. 1 or, alternatively located on opposite sides of the flow tube 108 at substantially the mid point between the bulkheads 104, as shown in FIGS. 2 and 3. Other source/detector configurations are also contemplated.

Now referring to FIG. 2, one embodiment of the present invention is illustrated comprising a flow tube 108, two coils 120, 124 connected to the housing 102, and two ferrous rods 122, 126 connected to the flow tube 108. The coils 120, 124 may also incorporate a ferrous core to form a more effective electromagnet. One coil 120 is connected by electrical leads 128 to a transmitter (not shown). Application of an alternating current to the coil 120 exerts an electromagnetic force on the rod 122, which causes the rod 122 to translate linearly, therefore imparting a vibration on the tube 108. The other coil 124 is connected by leads 130 to a receiver (not shown). The vibration in the tube 108 moves the rod 126 within the coil 124, therefore creating a voltage to generate at the leads 130 that is monitored by the receiver.

Now referring to FIG. 3, another vibration source 132 is illustrated, comprising a magnet 134 secured to the flow tube 108, and a single coil winding 136 secured to the housing 102. The coil 136 is connected by leads 138 to a transmitter (not shown). The coil 136 is mounted toward the outer extreme of the magnet 134 (this is exaggerated in the figure for clarity). The precise mounting location of the coil 136 may be empirically determined by maximizing the vibration force imparted upon the flow tube 108 Applying an alternating current to the coil 136 causes a resulting electromagnetic force that vibrates the flow tube 108.

Still in reference to FIG. 3, one embodiment of the vibration detector is illustrated comprising two magnets 138, 140 secured to the vibrating flow tube 108, and a dual coil winding 142 secured to the housing 102. The dual coil 142 is connected by leads 144 to a receiver (not shown). The symmetry axes of the magnets 138, 140 and dual coil 142 are aligned and the magnets 138, 140 are arranged such that their magnetic fields repel. The dual coil 142 may be composed of two identical coils mounted end-to-end with symmetry axes aligned and electrically connected in series. A schematic of the dual coil 142 is presented in FIG. 3A. The plane 146 defined by the interface of the magnets 138, 140 is aligned with plane 148 defined by the intersection of the opposing coil windings of the dual coil 142 as shown in FIG. 3. The coils are connected so as to be phased in such a way that minimal or no voltage is generated at the leads 144 if the coils are placed in a uniform magnetic field (such as that induced by current flow in the nearby vibration source). However, the coils do respond to movement of the opposed magnet pair. Vibration of the flow tube 108 causes the generation of a voltage across the leads 144 of the dual coil 142.

The arrangement of the vibration detector magnets 138, 140 may act to reduce the magnetic field created by the vibration detector, as well as the effects of the magnetic field created by the vibration source. The net effect of this arrangement is to decrease the interference created in the signal produced by the vibration detector, which allows variations in the vibration of the flow tube 108 to be more accurately and reliably detected.

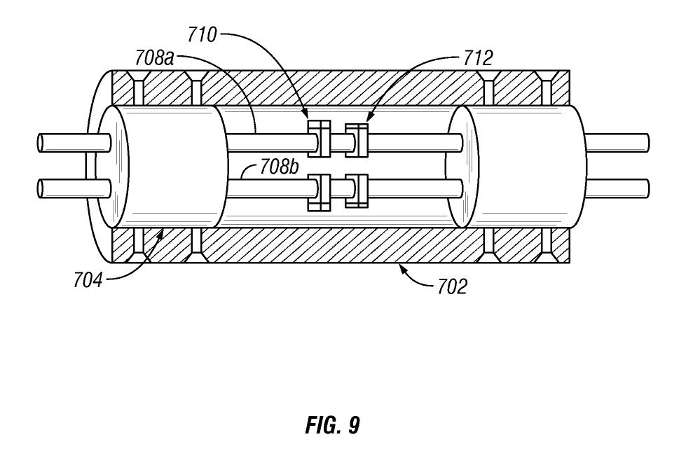

The measurement module may contain electronic circuits and devices that may have temperature, pressure, and time-dependent variations. The densitometer structure as a whole may also exhibit these variations. The densitometer may be exposed to temperature and pressure extremes over the device's lifetime, requiring recalibration to account for such variations. To reduce the need for frequent re-calibrations, a dual-tube densitometer, see FIG. 9, may possibly provide reduced calibration requirements. In this example embodiment, two flow tubes 708a, b are supported by bulkheads 704 in housing 702. Each tube may be vibrated by a source 710, and the vibrations detected by a vibration sensor 712. One of the flow tubes 708a is set up as a “vibration standard” that has a well-determined resonance frequency, and the resonance frequency of the other flow tube 708b, having the unknown sample therein, is measured relative to the resonance frequency of the standard, or reference, flow tube 708a. The sample flow tube 708b accepts a flow of the sample fluid, whose density is to be measured, in one end and discharges the flow from the other end.

In one example, the reference flow tube 708a is filled with water, as the properties of water are well known. Alternatively, the reference flow tube may be filled with a vacuum, a gas, or some other substance with well known density properties (e.g., a reference solid). For the present purposes, the reference tube is considered to contain a vacuum if at room temperature the internal pressure is less than 0.05 atmospheres. Any fluid in the reference flow tube may be subjected to the pressure and temperature of the sample fluid's environment. Temperature and pressure sensors (not shown) are provided to determine the temperature and pressure values of the sample and reference flow tubes 708a, b.

In one embodiment, the measurement module 706 employs a vibration source 710 and a vibration detector 712 to adaptively track the resonance frequency of the reference flow tube 708a. The measurement module 706 then measures the frequency of the vibration signal from the sample tube 708b relative to the resonance frequency signal from the reference tube 708a. In one embodiment, the measurement module adds the two signals to obtain a signal that exhibits a beat frequency. The frequency of the beats is equal to the (unsigned) difference between the resonance frequency and the frequency of the vibration signal. The sign of the difference can be determined in a number of ways. One method is to utilize a fluid in the reference tube 708a that is outside the anticipated density range (either lighter or heavier) of the sample. A second, different, reference tube (not shown) could be used to determine a second beat frequency. Another method is to de-tune the frequency of the sample tube from its resonant frequency and observe the change in the measured frequency difference. For example, if an increase in the driving frequency results in an increase of the frequency difference, the resonant frequency of the sample is greater than that of the reference. Alternatively, the drive frequency of the reference tube could be de-tuned with similar results. From the signed difference, the density of the unknown fluid can be determined. A method for determining the density of the unknown fluid is presented further below.

In some of the embodiments described, the vibration sources and vibration detectors may be mounted near an antinode (point of maximum displacement from the equilibrium position) of the mode of vibration they are intended to excite and monitor. It is contemplated that more than one mode of vibration may be employed (e.g. the vibration source may switch between multiple frequencies to obtain information from higher mode resonance frequencies). In one embodiment, the vibration sources and detectors may be positioned so as to be near antinodes for each of the vibration modes of interest.

The locations of nodes (points of zero vibrational amplitude) and antinodes are determined by the wavelength of the vibration mode, and by the mounting end conditions of the vibrating tube. The frequency, f, and wavelength, λ, are related to the speed of sound, v, in a material by the equation, v=fλ

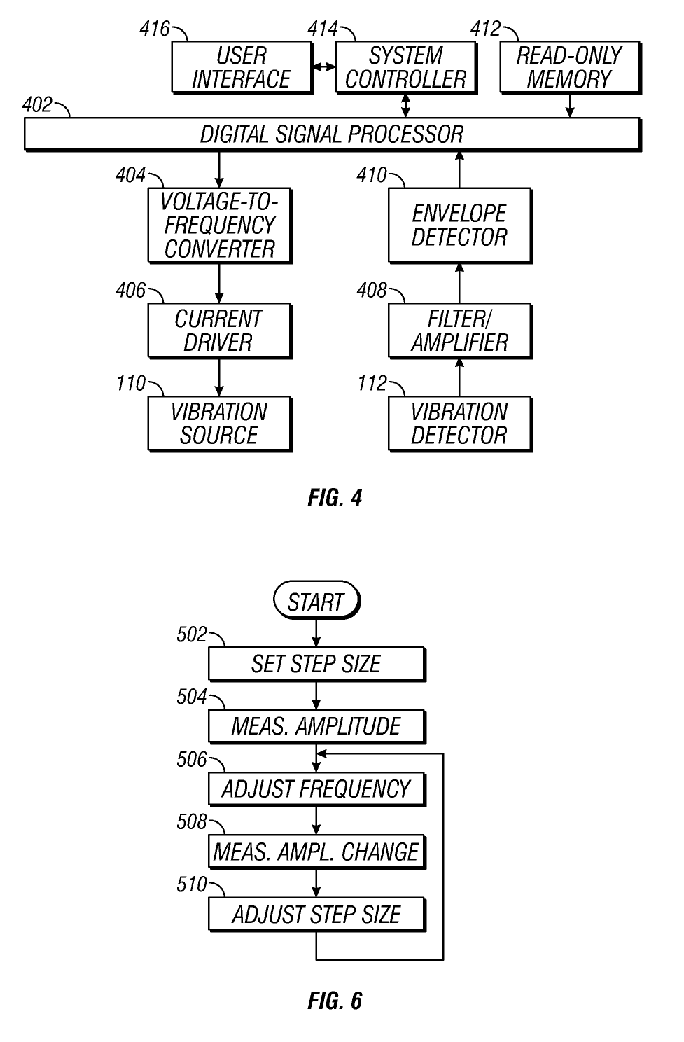

Referring now to FIG. 4, one embodiment of the measurement module may include a digital signal processor 402, voltage-to-frequency converter 404, current driver 406, filter/amplifier 408, amplitude detector 410, and read-only memory (ROM) 412. Read-only memory (ROM) 412 may be programmable read-only memory (PROM), electrically programmable read-only memory (EPROM), electrically erasable programmable read-only memory (EEPROM), and flash memory, or any other suitable substantially non-volatile read-only memory. The digital signal processor 402 may be configured and controlled by a system controller 414 that operates in response to actions of the user on the user interface 416. The system controller 414 may also retrieve measurements from the digital signal processor 402 and provide them to the user interface 416 for display to the user.

The digital signal processor 402 may execute a set of software instructions stored in memory 412. Typically, configuration parameters are provided by the software programmer so that some aspects of the digital signal processor's operation can be customized by the user via interface 416 and system controller 414. The set of software instructions may enable the digital signal processor 402 to perform density measurements according to one or more of the methods detailed further below. The digital signal processor may include digital to analog (D/A) and analog to digital (A/D) conversion circuitry and devices for providing and receiving analog signals to/from off-chip components. Most on-chip operations by the digital signal processor may be performed on digital signals.

The digital signal processor 402 may provide a voltage signal to the voltage-to-frequency converter 404. The voltage-to-frequency converter 404 produces a frequency signal having a frequency proportional to the input voltage. The current driver 406 receives this frequency signal and amplifies it to drive the vibration source 110. The vibration source 110 causes the flow tube to vibrate, and the vibrations are detected by vibration detector 112. A filter/amplifier 408 receives the detection signal from vibration detector 112 and provides some filtering and amplification of the detection signal before passing the detection signal to the amplitude detector 410. The filter/amplifier 408 serves to electrically isolate the vibration detector 112 from the amplitude detector 410 to prevent the amplitude detector 410 from electrically loading the vibration detector 112 and thereby adversely affecting the detection sensitivity. The amplitude detector 410 produces a voltage signal indicative of the amplitude of the detection signal. The digital signal processor 402 measures this voltage signal, and is thereby able to determine a vibration amplitude for the chosen vibration frequency.

The measurement module employs the vibration source 110 and vibration detector 112 to locate and characterize the resonance frequencies of the flow tube 108. Several different methods may be employed. In a first method, the measurement module may have programmed instructions stored therein that may cause the vibration source 110 to frequency “sweep” across the range of interest, and record the amplitude readings from the vibration detector 112 as a function of the frequency. As shown in FIG. 5, a plot of the vibration amplitude versus frequency will show a peak at the resonance frequency f₀. The resonance frequency can be converted to a density measurement, and the shape of the peak may yield additional information regarding properties of the sample fluid, for example, viscosity and multiple phase information.

In a second method, the measurement module may have programmed instructions stored therein that adaptively track the resonance frequency using a feedback control technique. One implementation of this method is shown in FIG. 6. An initial step size for changing the frequency is chosen in block 502. This step size can be positive or negative, to respectively increase or decrease the frequency. In block 504, the vibration source is activated and an initial amplitude measurement is made. In block 506, the vibration frequency is adjusted by an amount determined by the step size. In block 508, a measurement of the amplitude at the new frequency is made, and from this, an estimate of the derivative can be made. The derivative may be estimated to be the change in amplitude divided by the change in frequency, but the estimate may include some filtering to reduce the effect of measurement noise. From this estimated derivative, a distance and direction to the resonance peak can be estimated. For example, if the derivative is large and positive, then referring to FIG. 5 it becomes clear that the current frequency is less than the resonance frequency, but the resonance frequency is nearby. For small derivatives, if the sign of the derivative is changing regularly, then the current frequency is very near the resonance frequency. For small negative derivatives without any changes of sign between iterations, the current frequency is much higher than the resonance frequency. Returning to FIG. 6, this information is used to adjust the step size in block 510, and the digital signal processor 402 returns to block 506. This method may work best for providing a fast measurement response to changing fluid densities.

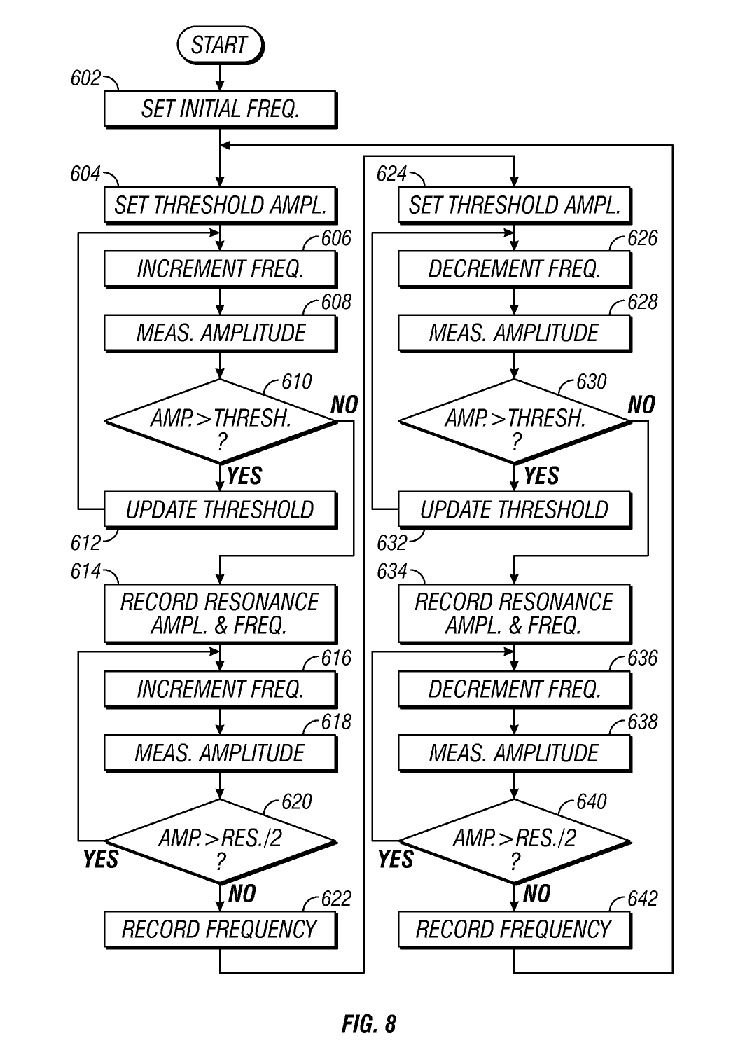

In a third method, the measurement module may have programmed instructions stored therein employing an iterative technique to search for the maximum amplitude as the frequency is discretely varied. Any of the well-known search algorithms for minima or maxima may be used. One illustrative example is now described, but it is recognized that the invention is not limited to the described details. In essence, the exemplary search method uses a back-and-forth search method in which the measurement module sweeps the vibration source frequency from one half-amplitude point across the peak to the other half-amplitude point and back again. One implementation of this method is shown in FIG. 8. In block 602, vibration is induced at an initial (minimum) frequency. In block 604, the vibration amplitude at the current vibration frequency is measured and set as a threshold. In block 606, the frequency is increased by a predetermined amount, and in block 608, the amplitude at the new frequency is measured. Block 610 compares the measured amplitude to the threshold, and if the amplitude is larger, then the threshold is set equal to the measured amplitude in block 612. Blocks 606-612 are repeated until the measured amplitude falls below the threshold. At this point, the threshold indicates the maximum measured amplitude, which occurred at the resonance peak. The amplitude and frequency are recorded in block 614. The frequency increases and amplitude measurements continue in blocks 616 and 618, and block 620 compares the amplitude measurements to half the recorded resonance frequency. Blocks 616-620 are repeated until the amplitude measurement falls below half the resonance peak amplitude, at which point, the half-amplitude frequency is recorded in block 622. Blocks 624-642 duplicate the operations of corresponding blocks 602-622, except that the frequency sweep across the resonance peak occurs in the opposite direction. For each peak crossing, the measurement module records the resonance amplitude and frequency, and then records the subsequent half-amplitude frequency. From this information the peak width and asymmetry can be determined, and the fluid density, viscosity, and multiple phase information may be calculated.

As noted previously, the measurement module may contain electronic circuits and devices that may have temperature, pressure, and time-dependent variations. Such variations may affect the resolution and accuracy of the frequency measurement, and hence introduce undesirable uncertainty in the density determination that is related to the frequency. In some cases, the least significant bits of an A/D device may be affected. One technique to increase the resolution and accuracy in the presence of the electronic variations is to increase the number of number of bits available from the A/D device. The availability of A/D devices suitable, for example, for downhole applications is limited. Using a higher resolution A/D to increase the resolution may not be feasible. Another technique to increase the resolution and accuracy of the frequency measurement in the presence of the variations is to increase the resonant frequency of the vibrating tube and the separation of the resonant frequencies for different fluid densities.

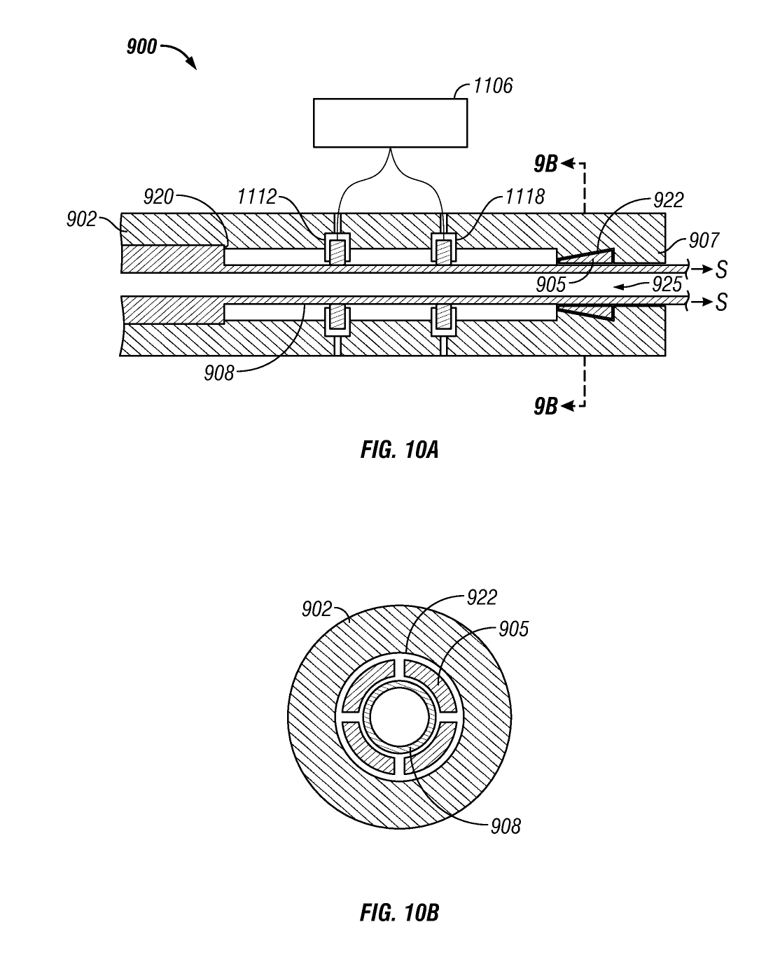

Referring to FIGS. 10A and 10B, an example of a tensioned densitometer 900 has a tube 908, having a longitudinal predetermined tension force, S, initially imposed thereon. As used herein, the term tensioned tube and pretensioned tube are used interchangeably and refer to a tube being longitudinally stretched such that an initial positive tension force is imposed thereon, as contrasted to an untensioned tube having no initial stretch or tension force applied to the tube. In one embodiment, tube 908 may be formed from a metallic material. Examples of suitable metallic materials include, but are not limited to, titanium, titanium alloys, and high temperature nickel based alloys, for example Hastaloy-C276 brand alloy, manufactured by Haynes International, Inc. In one embodiment, bulkhead 904 is attached, at one end, to tensioned tube 908 and reacts tension S on tensioned tube 908 against a shoulder 920 of housing 902. To maintain the tension on tensioned tube 908, in one example, tapered anchor members 905 may be forced into a tapered cavity in housing 902. In one embodiment, a threaded retaining nut 907 may engage threads on housing 902 and force tapered anchor members against the tapered surface 922 of a cavity in housing 902. Such action forces the tapered anchor members 905 to collapse around tube 908 and hold tube 908 in a fixed position, and under predetermined tension S. Tensioned tube 908 and housing 902 may be made of the same material, as indicated previously, to reduce differences in thermal expansion of the parts and reduce or eliminate loads imposed on tensioned tube 908 due to differential thermal expansion. FIG. 10B is a section view of FIG. 10A showing multiple anchor members 905 as they are wedged into tapered surface 922 thereby forcing anchor members 905 to firmly engage tensioned tube 908. In one embodiment, anchor members 905 may be collet fingers.

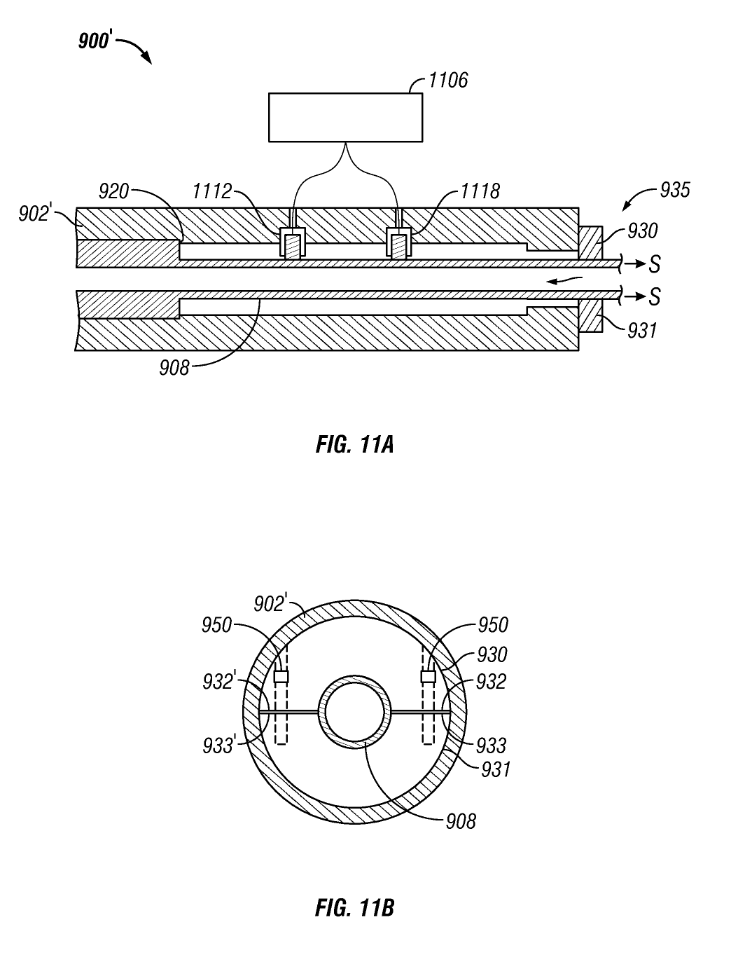

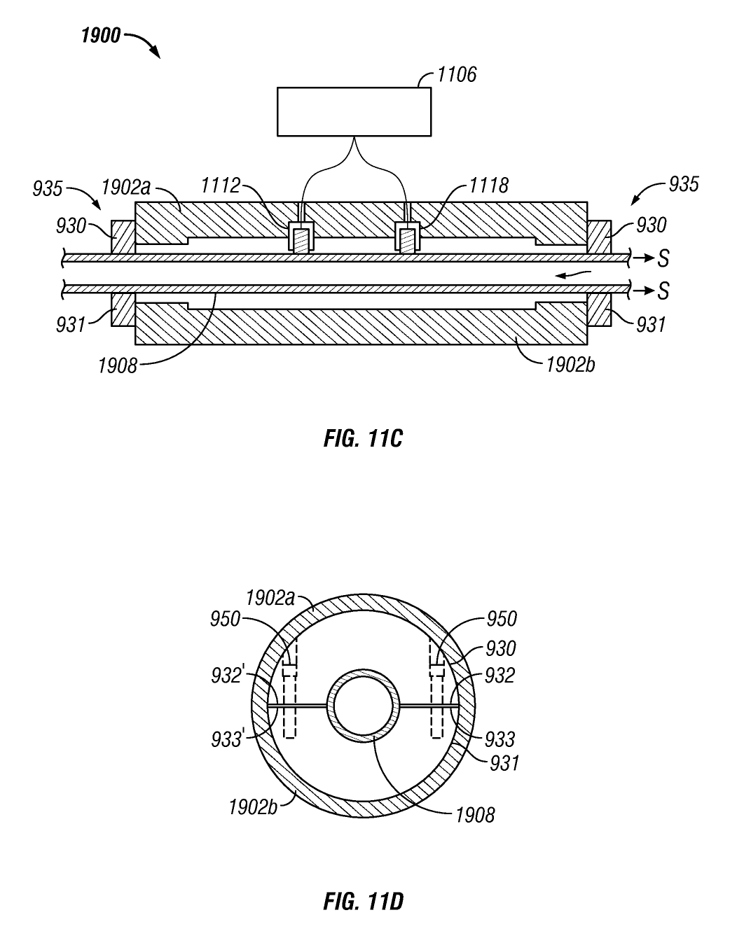

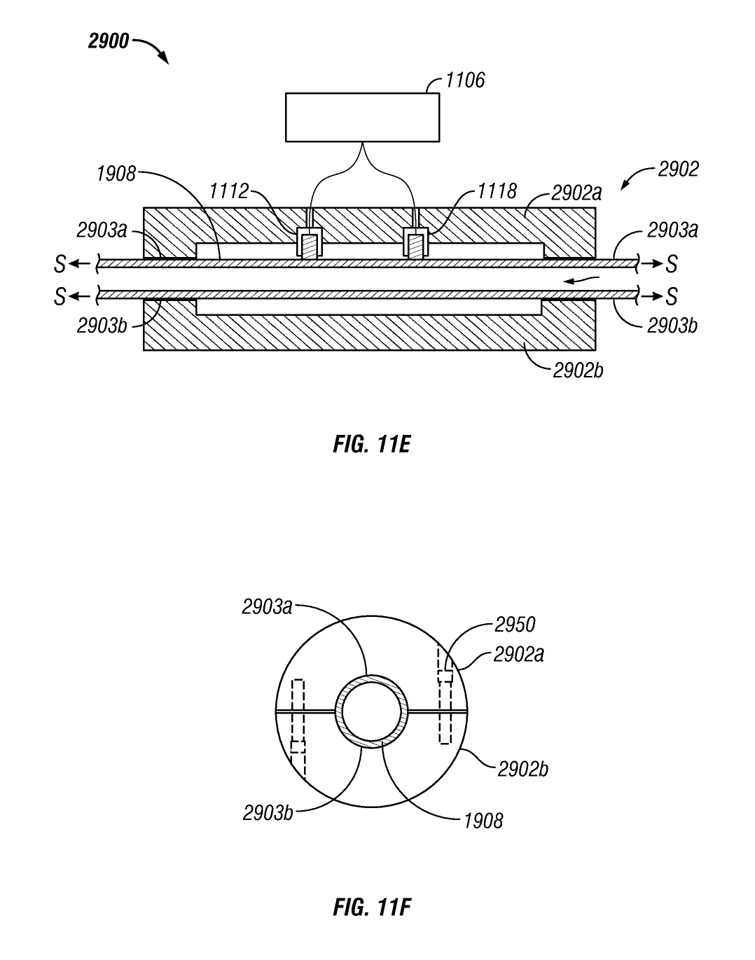

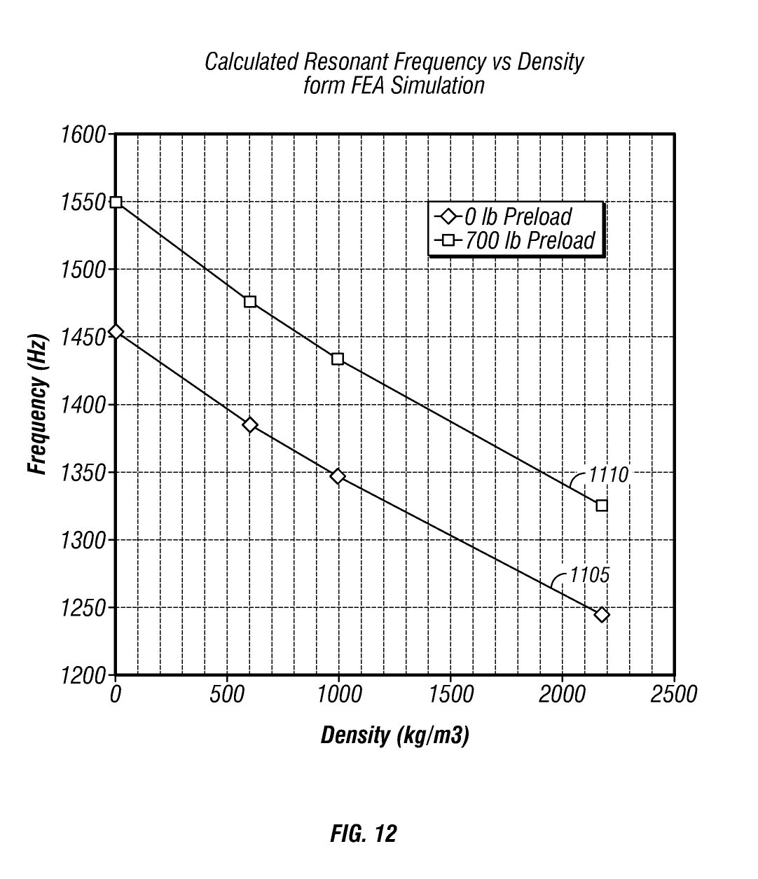

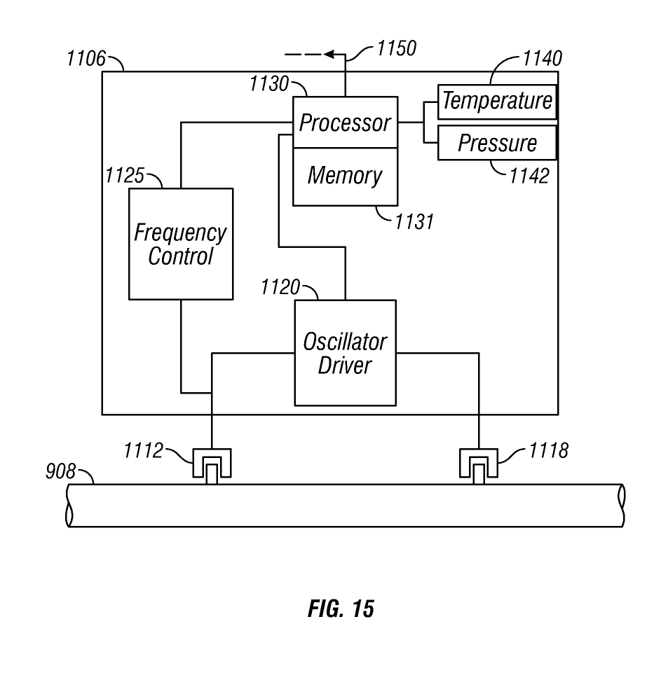

Referring to FIGS. 11A, 11B, and FIG. 15 tensioned tube densitometer 900′ comprises a split clamp 935 having a first member 930 and a mating second member 931 that may be assembled around tensioned tube 908 to grip and fixedly engage and retain tensioned tube 908 in a position that maintains tension S on tensioned tube 908. First member 930 and second member 931 may be fixed in operating position by, for example, threaded fasteners 950. Alternatively, first member 930 and second member 931 may be welded together along surfaces 932, 933, 932′ and 933′. Split clamp 935 may be attached to housing 902′.

In yet another alternative embodiment, see FIGS. 11C-D, a tensioned tube densitometer 1900 comprises split clamps 935 gripping tensioned tube 1908 on either end of housing members 1902a-b.

In still another alternative embodiment, see FIGS. 11E-F, a tensioned tube densitometer comprises a split housing 2902 having housing members 2002a and 2902b. Each housing member 2902a, b have an opening 2903 a, b, respectively, formed in each end thereof. Openings 2903 a, b are sized such that they fixedly clamp around tube 1908 when housing members 2902 a, b are fastened together by threaded fasteners 2950.

Referring now to FIGS. 10A-11F, and 15, vibration source 1118 and vibration receiver 1112 are attached to tensioned tube 908, 1908 and may be used in conjunction with measurement module 1106 to determine the resonant frequency of tensioned tube 908, 1908. In one example, vibration source 1118 comprises a magnet attached to tensioned tube 908, 1908 and a single coil placed proximate the magnet and supported by housing 902, 902′, 1902, 2902. Vibration receiver 1112 comprises a magnet attached to tensioned tube 908, 1908 and a split coil supported by housing 902, 902′, 1902, 2902 placed proximate the magnet. The split coil may be two coils wound, or wired, opposite each other. Movement of the magnet, do to tube vibration, induces a voltage in the coil.

Measurement module 1106, comprises an oscillator driver 1120 configured in a feedback loop using the received signal as a feedback source. This configuration uses tensioned tube 908, 1908 as an active member, in an oscillation circuit similar to that of a crystal oscillator, with the tube replacing the crystal. In one embodiment, oscillator driver 1120 drives tube 908, 1908 at the resonant frequency of at least one desirable mode of vibration of tube 908, 1908, as described below. Proper selection of components for such a drive circuit are within the capability of one skilled in the art, without undue experimentation. Frequency counter 1125 monitors the tube vibration frequency and transmits a value representative thereof to processor 1130. Processor 1130 may be in data communication with a memory 1131. At least one temperature sensor 1140 may be located to indicate the temperature of the sample fluid. In one example, multiple temperature sensors 1140 may be located at different locations in densitometer 900, 900′, 1900, 2900 to indicate temperature variations within tensioned tube densitometers 900, 900′, 1900, 2900. At least one pressure sensor may detect fluid pressure. The temperature and pressure readings may be used to mitigate their effects on the system. In one embodiment, processor 1130 may act according to instructions stored in memory 1131 to calculate a property of the fluid in situ. The fluid property may be stored in memory 1131 and/or transmitted via a telemetry channel 1150 to a second processor (not shown) for further analysis. Alternatively, processor 1130 may transmit raw data to a second processor (not shown) for determination of the fluid property. It will be apparent to one skilled in the art, that the techniques described with respect to FIG. 15 may be applied to an untensioned tube densitometer, as well.

In another embodiment, vibration source 1118, vibration receiver 1112, and measurement module 1106 may operate substantially the same way as the corresponding devices described herein with respect to FIGS. 1-8.

While described above with respect to a single tube tensioned densitometer, it will be apparent to one skilled in the art that the same predetermined tensioning technique may be applied to the dual tube densitometer described with respect to FIG. 9. It is also clear that the operational methods described herein with respect to FIG. 6 and FIG. 8 are equally applicable to the tensioned tube densitometer described herein.

### Calculational Model of Tensioned Tube Densitometer

One skilled in the at will appreciate that the resonant frequency, fₙ, of a longitudinally tensioned tube is a function of the tension on the tube, the density of the fluid in the tube, and the material properties of the tube. In one example, the tube may be modeled using finite element analysis (FEA) techniques. The results of such an analysis, for one example set of tube characteristics, is summarized below and in FIG. 11. The FEA analysis models a titanium tube having the following dimensions: length 6 in (152.4 mm), outside diameter 0.300 in (7.62 mm); inside diameter 0.21875 (5.56 mm). Fluid densities (kg/m³) modeled include: air 1.168; pentane 605.7; water 993; and cesium formate 2170.6.

The model results are listed in Table 2 and shown graphically in FIG. 11, where curve 1105 shows the resonant frequency for the model tube without tension as a function of density. Curve 1110 shows the results when a preload tension of 700 lb_{f} (3114 N) is imposed on the tube.

TABLE 2

| Fluid | Density (kg/m3) | 0 lb Tension | 700 lb Tension |
|---|---|---|---|
| Air | 1.168 | 1453.797 | 1549.249 |
| Pentane | 605.69 | 1386.015 | 1476.885 |
| Water | 993.08 | 1346.903 | 1435.086 |
| Cesium | 2170.61 | 1244.676 | 1325.738 |
| Formate | | | |

As can be seen from the calculated simulation, the resonant frequency for each fluid increases approximately 6.5% from the untensioned tube to the tensioned tube. In addition, the range of frequency over the density range of interest for a constant tension, increases approximately 6.8% from the untensioned tube to the tensioned tube. These increases are significant percentages considering that, for example, a ten bit A/D device has a resolution of 0.098% and a twelve bit A/D device has a resolution of 0.024%. The tension of the tube may be selected for a given resolution. In addition, the tension may be selected to put the measurement resonant frequency range in a frequency band that is relatively uncontaminated by production and/or drilling system noise. A suitable resonant frequency for the first vibrational mode of the described tensioned tube is estimated to be in the range of 1300 Hz to 2500 Hz. Other vibrational modes may also be used. Other tensions, tube materials, lengths, and wall thicknesses may affect the resonant frequency of a desirable vibration mode of the tube. One skilled in the art will appreciate that the tension force to achieve the frequency range is material and geometry dependent. The determination of the applicable force to achieve a desired resonant frequency of a tensioned tube at other conditions is within the ability of one skilled in the art, without undue experimentation.

The predicted results shown above are for fluids at substantially room temperature and pressure. To account for varying environmental temperatures and pressure, for example, the temperatures and pressures encountered in downhole applications, any of the densitometer example devices herein may be calibrated for varying conditions. Such calibrations may be determined using techniques known in the art. Such calibration information may be stored in either surface or downhole memory associated with the densitometer.

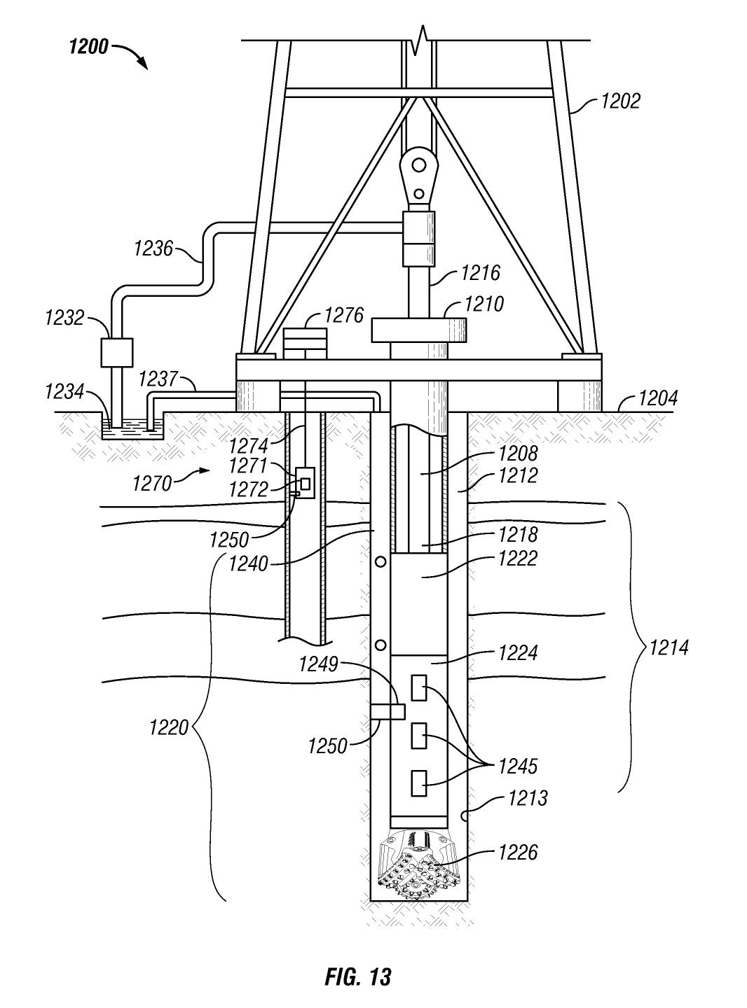

FIG. 13 illustrates an example system 1200 for drilling operations, according to an embodiment of the invention. System 1200 comprises a drilling rig 1202 located at a surface 1204 of a well. The drilling rig 1202 provides support for a drill string 1208. The drill string 1208 penetrates a rotary table 1210 for drilling a borehole 1212 through subsurface formations 1214. The drill string 1208 includes a kelly 1216 (in the upper portion), a drill pipe 1218, and a bottom hole assembly 1220 (located at the lower portion of the drill pipe 1218). The bottom hole assembly 1220 may include drill collars 1222, a downhole tool 1224, and a drill bit 1226. The downhole tool 1224 may be any of a number of different types of tools including measurement-while-drilling (“MWD”) tools, logging-while-drilling (“LWD”) tools, etc. The drill string 1208 may comprise wired and unwired drill pipe, as well as wired and unwired coiled tubing.

During drilling operations, the drill string 1208 (including the kelly 1216, the drill pipe 1218 and the bottom hole assembly 1220) may be rotated by the rotary table 1210. In addition or alternatively to such rotation, the bottom hole assembly 1220 may also be rotated by a motor (not shown) that is downhole. The drill collars 1222 may be used to add weight to the drill bit 1226. The drill collars 1222 also may stiffen the bottom hole assembly 1220 to allow the bottom hole assembly 1220 to transfer weight to the drill bit 1226. Accordingly, this weight provided by the drill collars 1222 also assists the drill bit 1226 in the penetration of the surface 1204 and the subsurface formations 1214.

During drilling operations, a mud pump 1232 pumps drilling fluid (known as “drilling mud”) from a mud pit 1234 through a hose 1236 into the drill pipe 1218 down to the drill bit 1226. The drilling fluid can flow out from the drill bit 1226 and return back to the surface through an annular area 1240 between the drill pipe 1218 and the sides of the borehole 1212. A hose or pipe 1237 returns the drilling fluid to the mud pit 1234, where such fluid is filtered. Accordingly, the drilling fluid can cool the drill bit 1226 as well as provide for lubrication of the drill bit 1226 during the drilling operation. Additionally, the drilling fluid removes the cuttings of the subsurface formations 1214 created by the drill bit 1226.

Downhole tool 1224 may include, in various embodiments, one or more different downhole sensors 1245, which monitor different downhole parameters and generate data that is stored within one or more different storage mediums within the downhole tool 1224. The type of downhole tool 1224, and the type of sensors 1245 thereon, depend on the type of downhole parameters being measured. Such parameters may include the downhole temperature and pressure, the various characteristics of the subsurface formations (such as resistivity, radiation, density, and porosity), the characteristics of the borehole (e.g., size, shape, and other dimensions), etc. The downhole tool 1224 further may include a power source 1249, such as a battery or generator. A generator could be powered either hydraulically or by the rotary power of the drill string. The downhole tool 1224 may also include a formation testing tool 1250. In an embodiment, the formation testing tool 1250 is mounted on a drill collar 1222. In one example, the formation testing tool 1250 engages the wall 1213 of the borehole 1212 and continuously extracts a sample of the fluid in the adjacent formation. The formation fluid may be passed through and/or by sensor modules in the formation testing tool 1250 to determine various properties of the formation fluid

FIG. 13 further illustrates an embodiment of a wireline system 1270 that includes a downhole tool body 1271 coupled to a surface unit 1276 by a logging cable 1274. The logging cable 1274 may include a wireline (multiple power and communication lines), a mono-cable (a single conductor), and a slick-line (no conductors for power or communications). The base 1276 is positioned above ground and may include support devices, communication devices, and computing devices. The tool body 1271 houses a formation testing tool 1250, that acquires fluid samples from the formation. The tool body 1271 may further include additional logging sensors 1272. In operation, a wireline system 1270 is typically sent downhole after the completion of a portion of the drilling. More specifically, the drill string 1208 creates a borehole 1212. The drill string is removed and the wireline system 1270 may be inserted into the borehole 1212.

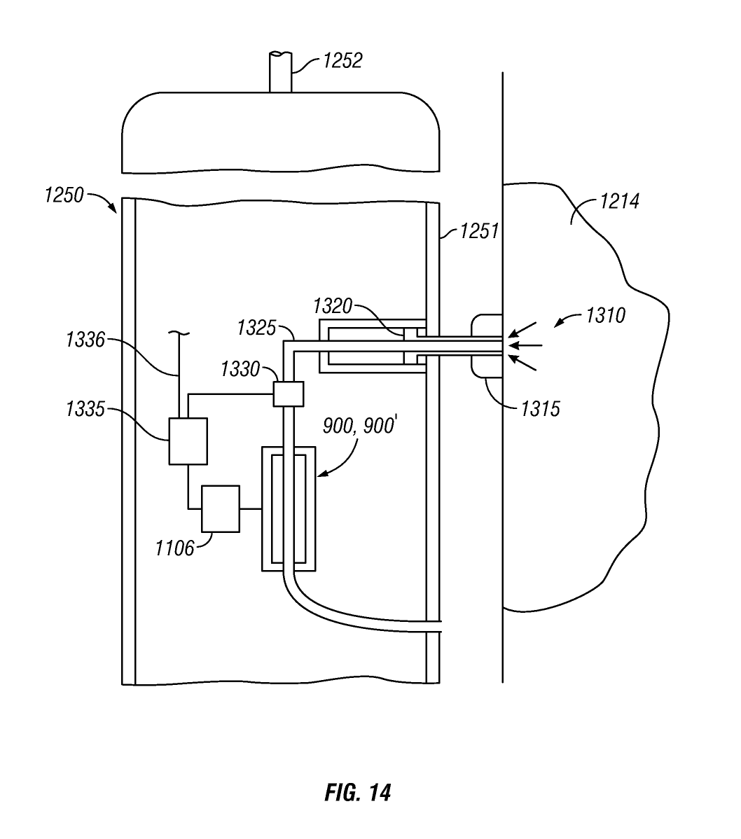

FIG. 14 shows a diagram of a formation testing tool 1250 that has been conveyed into a borehole 1212 on a longitudinal member 1252, and is located proximate subsurface formation 1214. Longitudinal member 1252 may comprise drill string 1208 and/or logging cable 1274. Probe 1315 may be extended from tool body 1251 by piston 1320 of formation testing tool 1250 and contacts wall 1213 of wellbore 1212. In one embodiment, the suction side of pump 1330 is in fluid communication with formation 1214 through flow passage 1325 that extends through piston 1320 and probe 1315. Activation of pump 1330 extracts a fluid sample 1310 from formation 1214. Fluid sample 1310 may be a liquid, a gas, or a combination of liquid and gas. Fluid sample 1310 may be forced through sensors and instruments, for example, tensioned tube densitometer 900 located in formation testing tool 1250. In one example, measurement module 106 of tensioned tube densitometer 900 is in data communication with controller 1335 of formation testing tool 1250. Controller 1335 may contain circuits and a processor with memory for controlling the operation of formation testing tool 1250. In one embodiment, controller 1335 transmits data from tensioned tube densitometer to the surface across data line 1336.

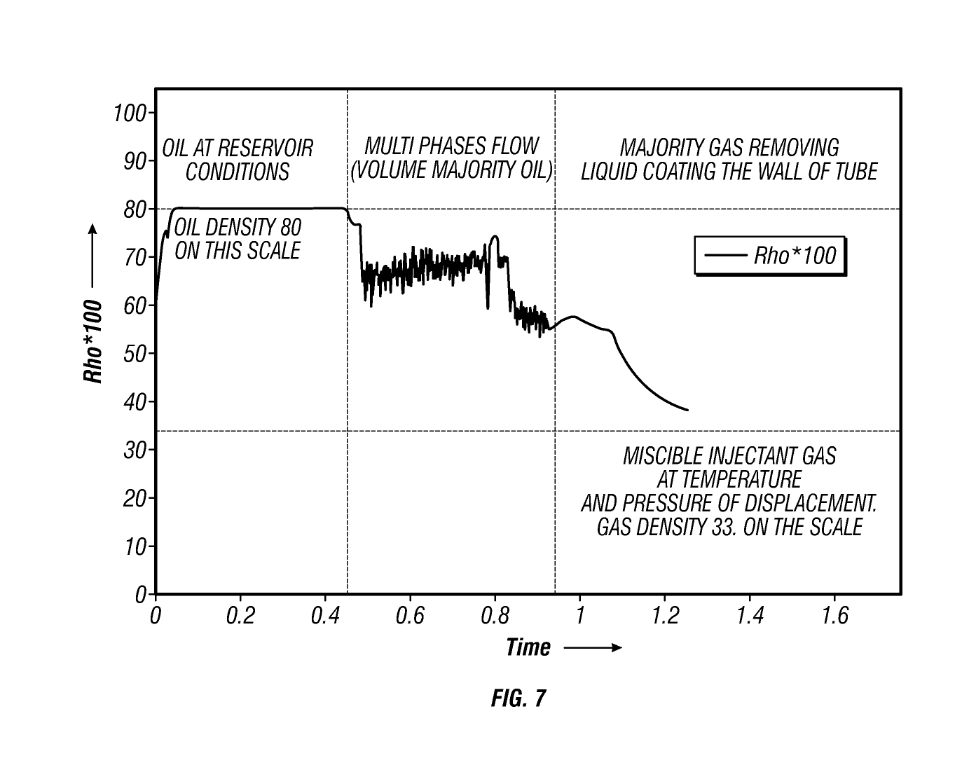

FIG. 7 shows an example of density measurements made with the disclosed tensioned tube densitometer and according to the disclosed methods as a function of time. Initially, the sample flow tube fills with oil, and the density measurement quickly converges to a specific gravity of 0.80. As a miscible gas is injected into the flow stream, the sample tube receives a multiple-phase flow stream, and the density measurement exhibits a significant measurement variation. As the flow stream becomes mostly gas, the oil forms a gradually thinning coating on the wall of the tube, and the density measurement converges smoothly to 0.33. It is noted, that in the multiple-phase flow region, the density measurement exhibits a variance that may be used to detect the presence of multiple phases.

Air or gas present in the flowing fluid affects the densitometer measurements. Gas that is well-mixed or entrained in the liquid may simply require slightly more drive power to keep the tube vibrating. Gas that breaks out, forming voids in the liquid, will reduce the amplitude of the vibrations due to damping of the vibrating tube. Small void fractions will cause variations in signals due to local variation in the system density, and power dissipation in the fluid. The result is a variable signal whose envelope corresponds to the densities of the individual phases. In energy-limited systems, larger void fractions can cause the tube to stop vibrating altogether when the energy absorbed by the fluid exceeds that available. Nonetheless, slug flow conditions can be detected by the flowmeter electronics in many cases, because they manifest themselves as periodic changes in measurement characteristics such as drive power, measured density, or amplitude. Because of the ability to detect bubbles, the disclosed densitometer can be used to determine the bubble-point pressure. As the pressure on the sample fluid is varied, bubbles will form at the bubble point pressure and will be detected by the disclosed device.

If a sample is flowing through the tube continuously during a downhole sampling event, the fluids will change from borehole mud, to mud filtrate and cake fragments, to majority filtrate, and then to reservoir fluids (gas, oil or water). When distinct multiple phases flow through the tube, the sensor output will oscillate within a range bounded by the individual phase densities. If the system is finely homogenized, the reported density will approach the bulk density of the fluid. To enhance the detection of bulk fluid densities, the disclosed measurement devices may be configured to use higher flow rates through the tube to achieve a more statistically significant sample density. Thus, the flow rate of the sample through the device can be regulated to enhance detection of multiple phases (by decreasing the flow rate) or to enhance bulk density determinations (by increasing the flow rate). If the flow conditions are manipulated to allow phase settling and agglomeration (intermittent flow or slipstream flow with low flow rates), then the vibrating tube system can be configured to accurately detect multiple phases at various pressures and temperatures. The fluid sample may be held stagnant in the sample chamber or may be flowed through the sample chamber.

Peak shapes in the frequency spectrum may provide signatures that allow the detection of gas bubbles, oil/water mixtures, and mud filtrate particles. These signatures may be identified using neural network “template matching” techniques, or parametric curve fitting may be used. Using these techniques, it may be possible to determine a water fraction from these peak shapes. The peak shapes may also yield other fluid properties such as compressibility and viscosity. The power required to sustain vibration may also serve as an indicator of certain fluid properties.

In addition, the resonance frequency (or frequency difference) may be combined with the measured amplitude of the vibration signal to calculate the sample fluid viscosity. The density and a second fluid property (e.g. the viscosity) may also be calculated from the resonance frequency and one or both of the half-amplitude frequencies. Finally, vibration frequency of the sample tube can be varied to determine the peak shape of the sample tube's frequency response, and the peak shape used to determine sample fluid properties.

The disclosed densitometer can be configured to detect fluid types (e.g. fluids may be characterized by density), multiple phases, phase changes and additional fluid properties such as viscosity and compressibility. The tube can be configured to be highly sensitive to changes in sample density and phases. For example, the flow tubes may be formed into any of a variety of bent configurations that provide greater displacements and frequency sensitivities. Other excitation sources may be used. Rather than using a variable frequency vibration source, the tubes may be knocked or jarred to cause an impulse vibration. The frequencies and envelope of the decaying vibration will yield similar fluid information and may provide additional information relative to the currently described variable frequency vibration source.

The disclosed devices can quickly and accurately provide measurements of downhole density and pressure gradients. The gradient information is expected to be valuable in determining reservoir conditions at locations away from the immediate vicinity of the borehole. In particular, the gradient information may provide identification of fluids contained in the reservoir and the location(s) of fluid contacts.

Numerous variations and modifications will become apparent to those skilled in the art once the above disclosure is fully appreciated. It is intended that the following claims be interpreted to embrace all such variations and modifications.

What is claimed is:

1. An apparatus comprising:
a tensioned sample tube that receives a fluid sample, the tensioned sample tube having a tension applied thereto; and
a vibration source and a vibration detector coupled to the tensioned sample tube.

2. The apparatus of claim 1 further comprising a measurement module driving the vibration source and detecting a resonant frequency of the tensioned sample tube and relating the resonant frequency of the tensioned sample tube to a property of the fluid therein.

3. The apparatus of claim 1 further comprising a housing supporting the tensioned sample tube.

4. The apparatus of claim 3 further comprising an anchor member engaged with the housing and the tensioned sample tube.

5. The apparatus of claim 4, wherein the predetermined tension results in a resonant frequency of the tensioned sample tube in the range of about 1300 Hz to about 2500 Hz.

6. The apparatus of claim 1, wherein the housing engages the tensioned sample tube to maintain a tension on the tensioned sample tube.

7. The apparatus of claim 2 wherein the tensioned sample tube is an active element of an oscillator driver.

8. The apparatus of claim 3 wherein the tensioned sample tube is welded to the housing.

9. The apparatus of claim 1 wherein the tensioned sample tube comprises a metallic material.

10. The apparatus of claim 1 wherein the tensioned sample tube comprises a titanium material.

11. The apparatus of claim 1 wherein the property of the fluid comprises fluid density.

12. A method of determining a property of a fluid comprising:
tensioning a sample tube;
receiving a sample of the fluid in the tensioned sample tube;
vibrating the tensioned sample tube;
detecting a resonant frequency of the tensioned sample tube; and
estimating the property of the fluid based on the detected resonant frequency of the tensioned sample tube.

13. The method of claim 12 wherein tensioning the sample tube comprises supporting the tensioned sample tube in a housing and anchoring the tensioned sample tube in the housing at the predetermined tension.

14. The method of claim 13 wherein anchoring the tensioned sample tube in the housing comprises clamping the tensioned sample tube between a first portion of the housing and a second portion of the housing.

15. The method of claim 12 wherein tensioning the sample tube to a predetermined tension results in a resonant frequency of the tensioned sample tube in the range of about 1300 Hz to about 2500 Hz.

16. The method of claim 12 wherein the property of the fluid comprises fluid density.

17. An apparatus for determining a property of a downhole fluid comprising:
a downhole tool extending in a wellbore proximate a subsurface formation;
a tensioned sample tube disposed in the downhole tool;
a sample of a formation fluid disposed in the tensioned sample tube; and
a vibration source and a vibration detector coupled to the tensioned sample tube.

18. The apparatus of claim 17 further comprising a measurement module driving the vibration source and detecting a resonant frequency of the tensioned sample tube and relating the resonant frequency of the tensioned sample tube to the property of the formation fluid therein.

19. The apparatus of claim 17 further comprising a housing supporting the tensioned sample tube.

20. The apparatus of claim 19 wherein the housing engages the tensioned sample tube to maintain a tension on the tensioned sample tube.

21. The apparatus of claim 18 wherein the tensioned sample tube is an active element of an oscillator circuit.

22. The apparatus of claim 17 wherein the predetermined tension results in a resonant frequency in the range of about 1300 Hz to about 2500 Hz.

23. The apparatus of claim 17 wherein the property of the fluid comprises fluid density.

24. A method for determining a property of a downhole fluid comprising:
extending a downhole tool in a wellbore proximate a subsurface formation;
extracting a sample of a fluid from the subsurface formation;
forcing the fluid sample through a tensioned sample tube in the downhole tool;
vibrating the tensioned sample tube;
detecting a resonant frequency of the tensioned sample tube; and
estimating the property of the downhole fluid based on the detected resonant frequency of the tensioned sample tube.

25. The method of claim 24 wherein the downhole tool is a formation testing tool.

26. The method of claim 24 wherein the property comprises density of the downhole fluid.
